(19) United States
(12) Patent Application Publication
(10) Pub. No.: US 2014/0146927 A1
(43) Pub. Date: May 29, 2014

(54) ADAPTIVE PROCESSOR

(71) Applicants: Mark Raifel, Ra'anana (IL); Amos Schreibman, Kfar Saba (IL); Eli Fogel, Herzliya (IL)

(72) Inventors: Mark Raifel, Ra'anana (IL); Amos Schreibman, Kfar Saba (IL); Eli Fogel, Herzliya (IL)

(73) Assignee: DSP Group Ltd., Herzeliya (IL)

(21) Appl. No.: 13/697,361

(22) PCT Filed: May 13, 2010
(86) PCT No.: PCT/IL10/00387

§ 371 Date: Nov. 28, 2012

(51) Int. Cl. H04L 25/02

(52) U.S. Cl. CPC H04L 25/0228
USPC 375/346

(57) ABSTRACT

A method and adaptive processor for estimating a reference signal, comprising receiving or determining a number of groups and respective group sizes, each group associated with a range of delay values of the reference signal, determining a multiplicity of coefficients, each coefficient associated with a specific delay of the reference signal, determining a multiplicity of weights, each weight associated with one of the groups, multiplying each sample of the reference signal having a delay by a corresponding coefficient to obtain a first product, and summing a multiplicity of first products associated with a group into a group sum signal sample, and multiplying each group sum by a weight associated with the group to obtain a second product, and summing all second products to obtain an estimated signal value.

### TECHNICAL FIELD

The present disclosure relates to an adaptive signal processor in general, and to an adaptively weighted processor structure, in particular.

### BACKGROUND

Adaptive processors are used for approximating signals, for purposes such as approximating undesired signals in order to cancel them.

Referring now to FIG. 1, showing a general usage of an adaptive processor.

x(k) (104) is a reference or input signal, wherein k is the time index. d(k) (108) is a signal associated with x(k), which may sometimes be a parasitic signal.

For example, x(k) may be voice to be transmitted over a telephone line, and d(k) can be an echo of x(k), which should be cancelled and not transmitted. Thus, adaptive processor 116 is aimed at attempting to generate a signal y(k) (120) which is based on x(k) (104) and is as similar as possible to d(k) (108). w(k) can be a stationary background noise or non-stationary interference like speech signal. d(k) (108) and w(k) are summed by adder 110 to generate s(k) (114). In the ideal case in which the estimated signal y(k) (120) is equal to d(k) (108), d(k) (108) and y(k) (112) will cancel each other at adder 124, leaving only w(k) (112) signal to be output. e(k) (128), which in the optimal case is equal to w(k) (112) is output and returned as a control feedback to adaptive processor 116, for adjusting the processor's parameters in order to minimize the error signal under a certain criteria, such as mean squared error (MSE), least squares (LS), mean absolute error (MAE) or others.

Adaptive processors can be used for applications such as but not limited to: adaptive prediction, system identification, control, echo cancellation, equalization, interference cancellation, noise cancellation, noise reduction, or the like.

A number of algorithms for approximating the adaptive processor parameters are known, such as least-mean squares (LMS), normalized LMS (NLMS), proportionate NLMS (PNLMS), block NLMS (BNLMS), multi-delay adaptive filtering (MDAF), recursive least squares (RLS), fast RLS (FRLS) or extensions thereof.

There is, however, a need in the art for an approximation algorithm that will provide enhanced performance. The performance can relate to any one or more parameters, such as but not limited to: convergence rate; misadjustment level in convergence, i.e., the distance between the error signal e(k) and the w(k) signal when complete convergence is achieved; adaptation robustness to noise signal w(k) (112); or reconvergence rate, i.e., the ability to track changes of the transfer function between the reference signal x(k) and desired signal d(k), and to readjust the adaptive processor.

### SUMMARY

A method and adaptive processor for estimating a reference signal using a dual stage or a hierarchic structure.

A first aspect of the disclosure relates to a method for estimating a reference signal using, comprising: receiving a reference signal; receiving a number of groups and respective group sizes, each group associated with a range of delay values of the reference signal; determining a multiplicity of coefficients, each coefficient associated with a specific delay of the reference signal; determining a multiplicity of weights, each weight associated with one of the groups; multiplying each sample of the reference signal having a delay by a corresponding coefficient to obtain a first product, and summing a multiplicity of first products associated with a group into a group sum signal sample; and multiplying each group sum signal sample by a weight associated with the group to obtain a second product, and summing all second products to obtain an estimated signal value. The method can further comprise determining the number of groups and respective group sizes. The method can further comprise: receiving an input signal sample; and subtracting the estimated signal sample from the input signal sample to receive an error signal sample. The method can further comprise feeding back the error signal into determining the multiplicity of coefficients or the multiplicity of weights. Optionally, within the method all group sizes are equal. Optionally, within the method the group sizes are determined so that all groups output substantially equal energy. Within the method, the coefficients are optionally determined as: h(0,n)=0 and

$$h ( k + 1 , n ) = h ( k , n ) + \frac{{μ}_{x} e ( k ) x ( k - n )}{N {σ}_{x}^{2} ( k ) + {β}_{x}}$$

for n=0 . . . N−1 wherein x is the reference signal, N is the size of the predetermine range of delay values. μₓ is a step-size parameter for the coefficients, βₓ is a regularization parameter, and σₓ²(k) is the energy of the reference signal sample. Within the method, the weights are optionally determined as: a(0, m)=1, and

$$a ( k + 1 , m ) = a ( k , m ) + \frac{{μ}_{u} e ( k ) u ( k , m )}{M {σ}_{u}^{2} ( k ) + {β}_{u}}$$

for m=0 . . . M−1 wherein u is the group sum sample, M is the number of groups, μᵤ is a step-size parameter for the weight, βᵤ is a regularization parameter, and σᵤ²(k) is the energy of the group sum signal. The method can further comprise an additional hierarchy layer dividing the input signal samples into further groups. The method can be used in an adaptive processor employing a method selected from the group consisting of: least-mean squares (LMS), normalized LMS (NLMS), proportionate NLMS (PNLMS), bi-block NLMS (BNLMS), multi-delay adaptive filtering (MDAF), and recursive least squares (RLS), and fast RLS (FRLS).

Another aspect of the disclosure relates to an adaptive processor for estimating a reference signal, the adaptive processor comprising: a component for receiving a number of groups and respective group sizes, each group associated with a range of delay values of the reference signal; a component for determining a multiplicity of coefficients, each coefficient associated with a specific delay of the reference signal; a component for determining a multiplicity of weights, each weight associated with one of the groups; a set of memory components for storing previous samples of the reference signal; a first set of adaptive filters for multiplying each sample of the reference signal having a delay by a corresponding coefficient to obtain a first product; a first set of adders for summing a multiplicity of first products associated with a group into a group sum signal sample; a second set of adaptive filters for multiplying each group sum signal sample by a weight associated with the group to obtain a second product; and a second adder for summing all second products to obtain an estimated signal value. The adaptive processor can further comprising a component for determining the number of groups and respective group sizes. The adaptive processor can further comprise a component for subtracting the estimated signal sample from the input signal sample to receive an error signal sample. Optionally, within the adaptive processor all group sizes are equal. Optionally, within the adaptive processor the group sizes are determined so that all groups output substantially equal energy. Within the adaptive processor the coefficients are optionally determined as: h(0,n)=0 and

$$h ( k + 1 , n ) = h ( k , n ) + \frac{{μ}_{x} e ( k ) x ( k - n )}{N {σ}_{x}^{2} ( k ) + {β}_{x}}$$

for n=0 . . . N−1 wherein x is the reference signal, N is the size of the predetermine range of delay values, μₓ is a step-size parameter for the coefficients, βₓ is a regularization parameter, and σₓ²(k) is the energy of the reference signal sample. Within the adaptive processor the weights are optionally determined as: a (0,m)=1, and

$$a ( k + 1 , m ) = a ( k , m ) + \frac{{μ}_{u} e ( k ) u ( k , m )}{M {σ}_{u}^{2} ( k ) + {β}_{u}}$$

for m=0 . . . M−1 wherein u is the group sum sample, M is the number of groups, μᵤ is a step-size parameter for the weight, βᵤ is a regularization parameter, and σᵤ²(k) is the energy of the group sum signal. The adaptive processor optionally employs a method selected from the group consisting of: least-mean squares (LMS), normalized LMS (NLMS), proportionate NLMS (PNLMS), block NLMS (BNLMS), multi-delay adaptive filtering (MDAF), and recursive least squares (RLS), and fast RLS (FRLS).

### BRIEF DESCRIPTION OF THE DRAWINGS

The present disclosure will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of a circuit using an adaptive processor;

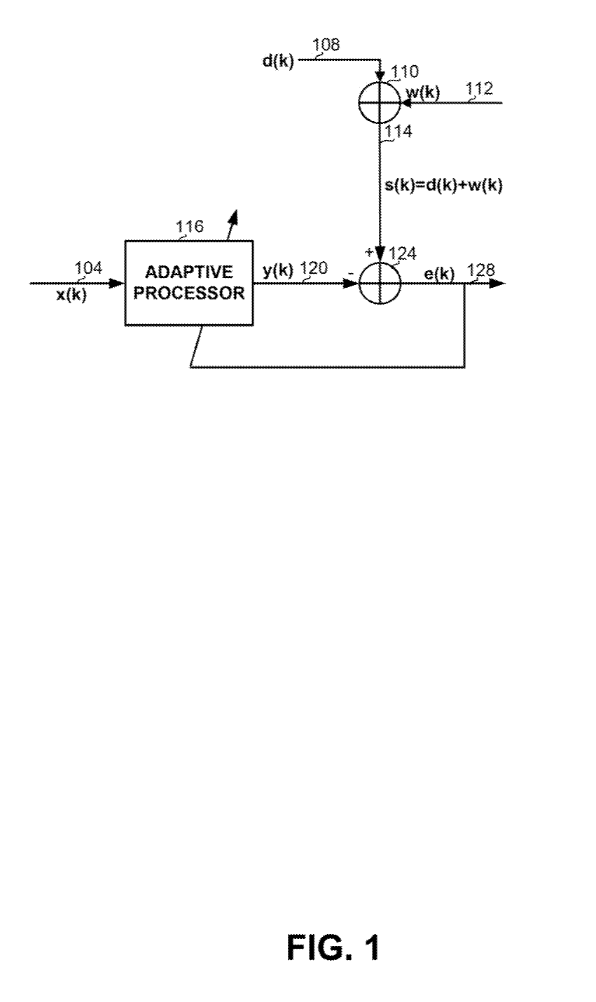

FIG. 2 is a schematic illustration of prior art adaptive filter;

FIG. 3 is a schematic illustration of an enhanced adaptive filter, in accordance with the disclosure; and

FIG. 4 is a flowchart of the main steps in the algorithm for implementing an adaptive processor, in accordance with the disclosure.

### DETAILED DESCRIPTION

The present invention overcomes the disadvantages of the prior art by providing a novel dual stage generic adaptive processor. For demonstration purposes only and without limiting the generality of the proposed processor and algorithms, the disclosure concentrates on enhancing the normalized least-mean squares (NLMS) algorithm. However, it will be appreciated by a person skilled in the art that the generic adaptive processor can be based on any known processor type, including but not limited to least-mean squares (LMS), normalized LMS (NLMS), proportionate NLMS (PNLMS), block NLMS (BNLMS), multi-delay adaptive filtering (MDAF), recursive least squares (RLS), fast RLS (FRLS) or extensions thereof.

The NLMS algorithm determines coefficients h(k) . . . h(k−N+1) for x(k) . . . x(k−N+1), and y(k) is determined as

$$y ( k ) = {\sum }_{n = 0}^{N - 1} h ( k , n ) x ( k - n ) ,$$

wherein N is the filter order, which is the number of samples, including the current sample of the x(k) signal, and the N−1 preceding samples.

The disclosed algorithm is dual stage, and adds a second hierarchy layer, such that the N samples are divided into M groups of size L, wherein L is smaller than N. The first stage consists of summing the products of the corresponding samples and coefficients within each group of L samples

$$( u ( k , m ) = {\sum }_{n = 0}^{L - 1} h ( k , n ) x ( k - mL - n ) ) .$$

Then on the second stage, each sum is multiplied by a coefficient a(k,0) . . . a(k,M−1), and the total output is determined as the sum

$$y ( k ) = {\sum }_{m = 0}^{M - 1} a ( k , m ) u ( k , m ) .$$

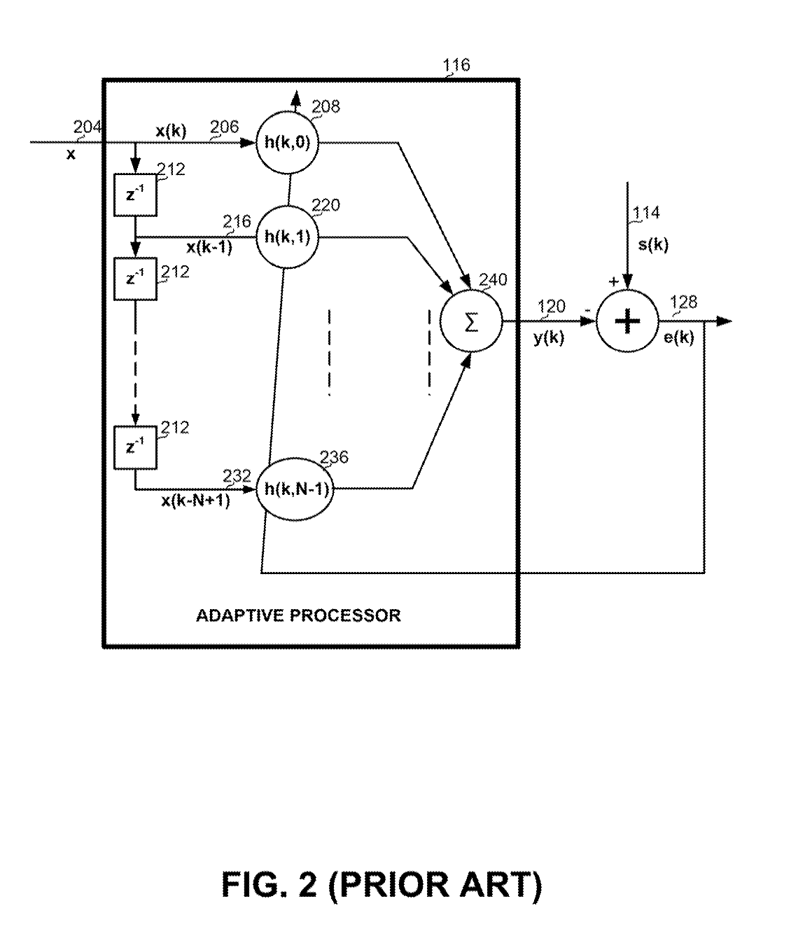

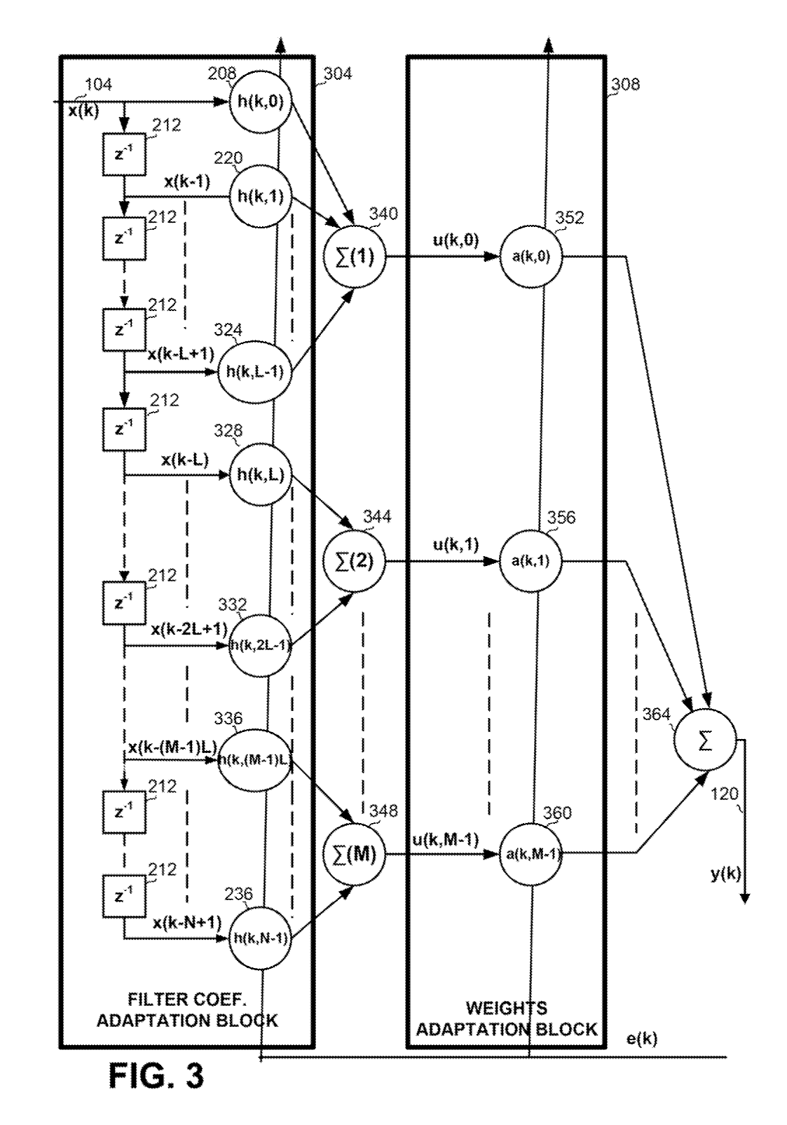

Referring now to FIG. 2, illustrating an embodiment of the basic NLMS algorithm. FIG. 3 is discussed below and will demonstrate the enhancement disclosed by the current disclosure.

N samples of input signal x (204) are sampled, thus providing x(k) (206), a preceding sample x(k−1) (216) as provided by delay 212, and so on until x(k−N+1) (232). In some embodiments the N signals are consecutive. Each sample is multiplied by a corresponding coefficient h(k,0) (208), h(k,1) (220) . . . h(k,N−1) (236).

The adaptive processor's output y(k) (120) is the sum of the multiplications as summed by adder 240 as follows:

$$y ( k ) = {\sum }_{n = 0}^{N - 1} h ( k , n ) x ( k - n ) .$$

The error, e(k) (128), is determined as

e(k)=s(k)−y(k). (Eq. 1)

The total energy of the k'th time index is defined as:

$${σ}_{x}^{2} ( k ) = \frac{1}{N} {\sum }_{n = 0}^{N - 1} {x}^{2} ( k - n )$$

The coefficients h(k,n) are determined as follows for each n between 0 and N−1, i.e., n=0 . . . N−1:

$$h ( 0 , n ) = 0 ;$$

$$h ( k + 1 , n ) = h ( k , n ) + \frac{μ e ( k ) x ( k - n )}{N {σ}_{x}^{2} ( k ) + β}$$

wherein μ is a constant ranging between about 0 and about 2 representing a step size, or the learning or adaptation pace. The lower μ is, the slower is the system convergence rate, and smaller misadjustment levels are achieved, and vice versa. β is a small constant, such as 0.01, required for avoiding division by zero where the input signal (x) is zero. It will be appreciated that the value of μ is constant for this example only, and does not reflect values to be used in other contexts.

As detailed above, the performance of the adaptive filter can be measured according to parameters which may include any one or more of the following: convergence rate, misadjustment level in convergence, adaptation robustness to noise signal, and reconvergence rate.

Sometimes tradeoff exists between the different parameters mentioned above. The step size μ may be used to balance between the measures. Some extensions of the NLMS algorithm try to outperform NLMS in one or more of the performance measures, while keeping the other measures intact, by using the same step size μ for the various algorithms, so that the measures are comparable. However, it is not always possible to fulfill this task. For example, in “Proportionate normalized least mean square adaptation in echo cancellers” by D. L. Duttweiler, published on IEEE Trans. Speech Audio Processing, vol. 8, pp. 508-518, September 2000, a proportionate NLMS algorithm is proposed in order to increase the convergence rate of the NLMS algorithm by keeping the convergence level intact. However, in this case, although the convergence rate is increased, the misadjustment level is increased as well.

Referring now to FIG. 3, showing a schematic illustration of the disclosed adaptively weighted NLMS algorithm, in which the samples are divided into groups, such that in addition to the coefficients multiplying the corresponding signal samples, the output of each group is assigned a corresponding weight.

The algorithm comprises two main blocks or steps: filter coefficients adaptation block 304 which operates similarly to adaptive processor 116 of FIG. 2, and weights adaptation block 308 which assigns weights to summed groups of outputs of filter coefficients adaptation block 304.

The N samples are divided into M groups. In some exemplary embodiments, all groups comprise the same number of samples L, such that M×L=N, but other divisions can be used as well, in which each group i has its own size Lᵢ, wherein

$${\sum }_{i = 0}^{M - 1} {L}_{i} = N .$$

The algorithm employs coefficients h(k, 0) (208), h(k, 1) (220), and h(k,N−1) (236) as described in association with FIG. 2 above. Also indicated in FIG. 3 are h(k,L−1) (324), h(k, L) (328), h(k, 2*L−1) (332) and h(k,N−1)(336) which are also present in the algorithm depicted in FIG. 2 but are not indicated on the figure itself. Alternative annotation can group the weights together, such as h(k,0,0) h(k,0,1) . . . h(k,0,L₀−1) for the first block, h(k,1,0) h(k,1,1) . . . h(k,1,L₁−1) for the second block, and so on until . . . h(k, L_{M-1},0) h(k, L_{M-1},1) . . . h(k, L_{M-1}, L_{M-1}−1) for the last block.

Each sample of each group of signals is multiplied by a corresponding coefficient, and all multiplications associated with a particular group are summed. For example Σ(1)(340) sums the products of the first group and outputs u(k, 0), Σ(2)(344) sums the products of the second group and outputs u(k, 1), . . . Σ(M) (348) sums the products of the M-th group and outputs u(k, M−1). Thus, the output of each group is determined as follows:

$$\begin{matrix} u ( k , 0 ) = \text{?} h ( k , l ) x ( k - \text{?} ) , \\ and & ( Eq . 2 ) \\ u ( k , m ) = \text{?} h ( k , {\sum }_{i = 0}^{m - 1} {L}_{i} + \text{?} ) x ( k - ( {\sum }_{i = 0}^{m - 1} {L}_{i} + \text{?} ) ) \\ for m = 1 , … , M - 1 \\ \text{?} \text{indicates text missing or illegible when filed} & ( Eq . 3 )\end{matrix}$$

The output of each group m is then multiplied by a corresponding weight a(k,m), such that the output y(k) is determined as follows:

$$y ( k ) = {\sum }_{m = 0}^{M - 1} a ( k , m ) u ( k , m ) \qquad ( Eq . 4 )$$

As before, the estimated energy of the relevant sample of the x signal is determined as follows:

$${σ}_{x}^{2} ( k ) = \frac{1}{N} {\sum }_{n = 0}^{N - 1} {x}^{2} ( k - n ) ,$$

wherein x²(k−n) refers to the x(k−n) sample, squared, and the total energy of signal u which is the output of a particular group is:

$${σ}_{u}^{2} ( k ) = \frac{1}{M} {\sum }_{m = 0}^{M - 1} {u}^{2} ( k , m )$$

wherein u²(k,m) refers to the u(k,m) sample, squared.
The h coefficients and the a weights are determined as follows:

$$\begin{matrix}h ( 0 , n ) = 0 ; \\ h ( k + 1 , n ) = h ( k , n ) + \frac{{μ}_{x} e ( k ) x ( k - n )}{N {σ}_{x}^{2} ( k ) + {β}_{x}} \\ for n = 0 … N - 1 \\ and & ( Eq . 5 ) \\ a ( 0 , m ) = 1 , \\ a ( k + 1 , m ) = a ( k , m ) + \frac{{μ}_{u} e ( k ) u ( k , m )}{M {σ}_{u}^{2} ( k ) + {β}_{u}} \\ for m = 0 … M - 1 & ( Eq . 6 )\end{matrix}$$

wherein N is the filter order as in NLMS, M is the number of groups or blocks and Lₘ is the length of sub-block m. μₓ and μᵤ are, respectively, step-size parameters for the filter coefficients and weights. Similarly, βₓ and βᵤ are the regularization factors in order to prevent zero division of the normalization parts. The weights of the adaptive filter, a(k,m) may be initially set to 1, i.e., all groups are assigned the same weight, which coincides with the NLMS algorithm. However, any other initial conditions can be used as well.

In the disclosed two-stage filtering scheme, updating the coefficients h is done using the full filter order of N, substantially as in the NLMS algorithm. In the first stage, x(k) is filtered in M different blocks to generate intermediate signals u(k,m). In the second stage the M temporary signals u(k,m) are used as reference signals to weight adaptation block 308. Thus, u(k,m) is filtered (weighted) by the secondary filter weights a(k,m) in order to refine the signal y(k). When a(k,m)=1 for all m, the proposed algorithm is equivalent to NLMS.

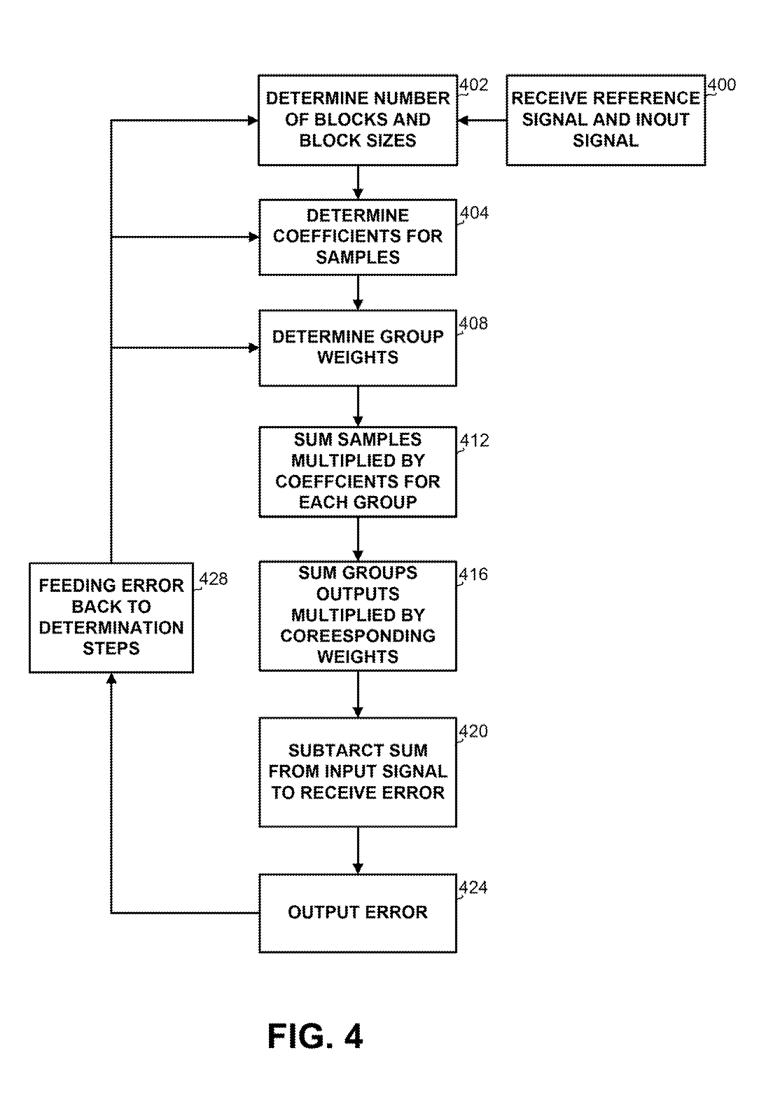

Referring now to FIG. 4, showing a flowchart of the main steps in the algorithm for implementing an adaptive processor.

On ongoing step 400, reference signal x(k) and optionally an input signal s(k) are received. It will be appreciated that a sample of each of the signals is received on each clock cycle, and that the used time window, i.e., the number of past samples considered on each cycle can be set to a constant value, or be adaptive in accordance with the resulting effect.

On group number and size determination step 402, the number of groups or blocks M to which the reference signal samples are divided to, and the size of each group, Lᵢ for each i between 0 and M−1 are determined, based on factors such as the available processing power, required processing time, required convergence rate, keeping the energy levels of the blocks as uniform as possible as suggested in equations 7-9 below, or others.

Each sample is multiplied by a corresponding coefficient h, and all products associated with a particular group are summed and then multiplied by a corresponding weight a.

In some embodiments, a division in which the number of blocks and the block sizes are the square root of the number of samples can be used. If the square root is not an integer, then the numbers can be rounded so that the product of the number of groups by the group size equals to the number of samples.

In an alternative embodiment, the number of groups and the group sizes are received from an external source or retrieved from memory rather than determined.

It will be appreciated that the following steps are significant only after the sample buffer is full, and the required number of samples had been received.

On coefficient determination step 404, the h(k, 0) . . . h(k, N−1) coefficients for clock cycle k are determined, wherein h(k, 0) is the coefficient of the current sample, h(k, 1) is the coefficient of the previous sample, and so on. The coefficients can be determined using for example Eq. 5 detailed in association with FIG. 3 above. Thus, each coefficient is associated with a particular delay of the signal.

On step 408, the a(k, 0) . . . a(k, M−1) weights associated with each group are determined, wherein a(k, 0) is the coefficient of the first group which relates to the latest L samples of the input signal wherein L is the group size, a(k, 1) is the weight of the L samples preceding the latest L samples, and so on. It will be appreciated that the above scheme can be modified for group sizes which vary rather than uniform ones. The coefficients can be determined using for example Eq. 6 detailed in association with FIG. 3 above.

On step 412 each sample i of the reference signal is multiplied by the coefficient h(k, i) having the corresponding delay. Alternatively, another mathematical or logical operation can be performed between the sample and the coefficient. All products are then summed to produce the intermediate signals, indicated by u(k, i) wherein i is between 0 and the number of groups as an example this process is can be achieved by employing equation 2 or equation 3 above.

On step 416 the output samples associated with each group, indicated by u(k, i), are multiplied or otherwise combined with the corresponding weights a(k, i). The products are then summed or otherwise combined to generate sample of y(k) (120) signal sample, as an example this process is can be achieved by using equation 4 above.

On subtraction step 420, the sample of summed signal y(k) (120) is subtracted or otherwise compared to the corresponding sample of input signal s(k) (114) to generate a sample of error signal e(k) (128) as demonstrated by equation 1 above.

On output step 424 the samples of error signal e(k) (128) are output, and on optional feedback step 428 the samples of error signal e(k) (128) are fed back to any one or more of the preceding steps: number of blocks and block size determination step 402, coefficient determination step 404, or weight determination step 408 detailed above. Error signal e(k) (128) can be fed back as a control signal for enhancing the operation of the processor.

The proposed algorithm and circuit outperforms the NLMS algorithm in the convergence rate, reconvergence rate and robustness to noise signal parameters, while keeping the misadjustment level intact in a multiplicity of cases.

The convergence rate is improved relatively to the prior art NLMS algorithm, since only the relevant groups receive positive weights, and due to the feedback of error e(k) the weights are further amplified. This is particularly relevant for sparse systems, such as line or electrical echo canceller, in which the relevant groups will get higher weights, thereby reducing the overall weight misadjustment noise without harming the system convergence rate.

Some enhancements can be implemented for the disclosed weighted adaptive algorithm. For example, in order to accelerate the reaction of the algorithm to echo path change, e.g., when a speaker changes his location relatively to the microphone which requires re-convergence of the algorithm, the adaptive weights a(k, m) can be regulated in the following manner:

a(k,m)=max(a(k,m),δ) wherein δ is a regulating factor, whose value can change according to the system state, e.g., initial convergence, double talk, re-convergence, or other conditions. This regulation is particularly useful where a*h is a constant, in which case this limitation will disable extreme values of a or h.

In another enhancement, the lengths of the groups or blocks length can be chosen arbitrarily, and not necessarily be equal. For example, the group lengths can be so as each block maintains the same energy level E, i.e.,

$$\begin{matrix} {a}^{2} ( k , 0 ) \text{?} {‖ h ( k , \text{?} ) ‖}^{2} = E \\ for m = 0 \\ and & ( Eq . 7 ) \\ {a}^{2} ( k , m ) \text{?} {‖ h ( k , \text{?} \text{?} + \text{?} ) ‖}^{2} = E \\ for m = 1 … M - 1 \\ \text{?} \text{indicates text missing or illegible when filed} & ( Eq . 8 )\end{matrix}$$

and therefore

$$E = \frac{1}{M} [ {\sum }_{m = 0}^{M - 1} {a}^{2} ( k , m ) \text{?} {‖ h ( k , \text{?} \text{?} + \text{?} ) ‖}^{2} ] \\ \text{?} \text{indicates text missing or illegible when filed} \qquad ( Eq . 9 )$$

Solving the above equation system provides the values of the block lengths, Lᵢ.

It will be appreciated that the above disclosure relates also to an adaptive processor for estimating a reference signal, the adaptive processor comprising a component for receiving or determining a number of groups and respective group sizes, each group associated with a predetermine range of delay values of the reference signal; a component, such as a control component for determining a multiplicity of coefficient, each coefficient associated with a predetermined delay of the reference signal; a component, such as a control component for determining a multiplicity of weights, each weight associated with one of the groups; a set of delays, which can be implemented as memory components for storing previous samples of the reference signal; a first set of adaptive filters for multiplying each sample of the reference signal having a delay by a corresponding coefficient to obtain a first product; a first set of adders for summing the multiplicity of first products associated with each group into a group sun signal sample; a second set of adaptive filters for multiplying each group sum signal sample by a weight associated with the group to obtain a second product; and a second adder for summing all second products to obtain an estimated signal value.

It will be appreciated that the disclosed algorithm and adaptive processor can be implemented in a variety of techniques, including firmware ported for a specific processor such as digital signal processor (DSP) or microcontrollers, or can be implemented as hardware or configurable hardware such as field programmable gate array (FPGA) or application specific integrated circuit (ASIC).

Alternatively, the disclosure can be implemented as software, e.g., interrelated sets of computer instructions, arranged as executables, libraries, web pages, portals or other units designed to be executed by a computing platform such as a general purpose computer, a personal computer, a mainframe computer, a server, a mobile device, or any other type of computing platform provisioned with a memory device, a CPU or microprocessor device, and I/O ports.

It will be appreciated that although part of the disclosure was related in an exemplary way to NLMS processors, it is not limited to such and can be used with any known processor type, including but not limited to least-mean squares (LMS), normalized LMS (NLMS), proportionate NLMS (PNLMS), block NLMS (BNLMS), multi-delay adaptive filtering (MDAF), recursive least squares (RLS), fast RLS (FRLS) or extensions thereof.

It will also be appreciated that an enhancement of the method and algorithm can use more than the two levels described, and introduce further levels.

It will be appreciated that multiple implementations and variations of the method and algorithm can be designed. Various considerations and alternatives thereof can be considered for determining the number of blocks and the block sizes, the coefficients and the weights.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step of component to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A method for estimating a reference signal using, comprising:
receiving a reference signal;
receiving a number of groups and respective group sizes, each group associated with a range of delay values of the reference signal;
determining a multiplicity of coefficients, each coefficient associated with a specific delay of the reference signal;
determining a multiplicity of weights, each weight associated with one of the groups;
multiplying each sample of the reference signal having a delay by a corresponding coefficient to obtain a first product, and summing a multiplicity of first products associated with a group into a group sum signal sample; and
multiplying each group sum signal sample by a weight associated with the group to obtain a second product, and summing all second products to obtain an estimated signal value.

2. The method of claim 1 further comprising determining the number of groups and respective group sizes.

3. The method of claim 1 further comprising:
receiving an input signal sample; and
subtracting the estimated signal sample from the input signal sample to receive an error signal sample.

4. The method of claim 3 further comprising feeding back the error signal into determining the multiplicity of coefficients or the multiplicity of weights.

5. The method of claim 1 wherein all group sizes are equal.

6. The method of claim 1 wherein the group sizes are determined so that all groups output substantially equal energy.

7. The method of claim 1 wherein the coefficients are determined as: h(0,n)=0 and
$$h ( k + 1 , n ) = h ( k , n ) + \frac{\text{?} e ( k ) x ( k - n )}{N {σ}_{x}^{2} ( k ) + {β}_{x}}$$
$$\text{?} \text{indicates text missing or illegible when filed}$$
for n=0 . . . N−1 wherein x is the reference signal, N is the size of the predetermine range of delay value [symbol] ,μx is a step-size parameter for the coefficients, βₓ is a regularization parameter, and σ [symbol] ²(k) is the energy of the reference signal sample.

8. The method of claim 1 wherein the weights are determined as: a (0,m)=1, and
$$a ( k + 1 , m ) = a ( k , m ) + \frac{\text{?} e ( k ) u ( k , m )}{M {σ}_{u}^{2} ( k ) + {β}_{u}}$$
$$\text{?} \text{indicates text missing or illegible when filed}$$
for m=0 . . . M−1 wherein u is the group sum sample, M is the number of groups, μᵤ is a step-size parameter for the weight, βᵤ is a regularization parameter, and σᵤ²(k) is the energy of the group sum signal.

9. The method of claim 1 further comprising an additional hierarchy layer dividing the input signal samples into further groups.

10. The method of claim 1 wherein the groups, weights and coefficients are used in an to adaptive processor employing a method selected from the group consisting of: least-mean squares (LMS), normalized LMS (NLMS), proportionate NLMS (PNLMS), block NLMS (BNLMS), multi-delay adaptive filtering (MDAF), recursive least squares (RLS), and fast RLS (FRLS).

11. An adaptive processor for estimating a reference signal, the adaptive processor comprising:
a component for receiving a number of groups and respective group sizes, each group associated with a range of delay values of the reference signal;
a component for determining a multiplicity of coefficients, each coefficient associated with a specific delay of the reference signal;
a component for determining a multiplicity of weights, each weight associated with one of the groups;
a set of memory components for storing previous samples of the reference signal;
a first set of adaptive filters for multiplying each sample of the reference signal having a delay by a corresponding coefficient to obtain a first product;
a first set of adders for summing a multiplicity of first products associated with a group into a group sum signal sample;
a second set of adaptive filters for multiplying each group sum signal sample by a weight associated with the group to obtain a second product; and
a second adder for summing all second products to obtain an estimated signal value.

12. The adaptive processor of claim 11 further comprising a component for determining the number of groups and respective group sizes.

13. The adaptive processor of claim 11 further comprising a component for subtracting the estimated signal sample from the input signal sample to receive an error signal sample.

14. The adaptive processor of claim 11 wherein all group sizes are equal.

15. The adaptive processor of claim 11 wherein the group sizes are determined so that all groups output substantially equal energy.

16. The adaptive processor of claim 11 wherein the coefficients are determined as:
$$h ( 0 , n ) = 0$$
$$and$$
$$h ( k + 1 , n ) = h ( k , n ) + \frac{{μ}_{x} e ( k ) x ( k - n )}{N {σ}_{x}^{2} ( k ) + {β}_{x}}$$
for n=0 . . . N−1 wherein x is the reference signal, N is the size of the predetermine range of delay values, μₓ is a step-size parameter for the coefficients, βₓ is a regularization parameter, and σₓ²(k) is the energy of the reference signal sample.

17. The adaptive processor of claim 11 wherein the weights are determined as:
$$a ( 0 , m ) = 1 , \\ and$$
$$a ( k + 1 , m ) = a ( k , m ) + \frac{\text{?} e ( k ) u ( k , m )}{M {σ}_{u}^{2} ( k ) + {β}_{u}}$$
$$\text{?} \text{indicates text missing or illegible when filed}$$
for m=0 . . . M−1 wherein u is the group sum sample, M is the number of groups, μᵤ is a step-size parameter for the weight, βᵤ is a regularization parameter, and σᵤ²(k) is the energy of the group sum signal.

18. The adaptive processor of claim 11 wherein the adaptive processor employs a method selected from the group consisting of: least-mean squares (LMS), normalized LMS (NLMS), proportionate NLMS (PNLMS), block NLMS (BNLMS), multi-delay adaptive filtering (MDAF), recursive least squares (RLS), and fast RLS (FRLS).
